(19) United States
(12) Patent Application Publication
(10) Pub. No.: US 2012/0011021 A1
(43) Pub. Date: Jan. 12, 2012

(54) SYSTEMS AND METHODS FOR INTELLIGENT IMAGE PRODUCT CREATION

(76) Inventors: Wiley H. Wang, San Francisco, CA (US); Eugene Chen, Belmont, CA (US)

(21) Appl. No.: 13/164,997

(22) Filed: Jun. 21, 2011

Related U.S. Application Data
(60) Provisional application No. 61/363,337, filed on Jul. 12, 2010.

(51) Int. Cl. G06K 9/36; G06Q 30/00

(52) U.S. Cl. 705/26.5; 382/284

(57) ABSTRACT

A method for creating an image product design includes storing a plurality of page layouts for an image product, receiving a selection of one or more images for a page of an image product design by a computer system, automatically selecting a first page layout in the plurality of page layouts according to the sizes of the one or more images, and producing the image product design comprising the first page layout that incorporates the one or more images.

The present application claims priority to pending U.S. Provisional Patent Application 61/363,337, titled “Systems and methods for intelligent image product creation”, filed on Jul. 12, 2010 by the same inventors, the disclosure of which is incorporated herein by reference.

### TECHNICAL FIELD

This application relates to utilization of digital images, and more specifically, to the design and creation of products incorporating digital images.

### BACKGROUND OF THE INVENTION

In recent years, photography has been rapidly transformed from chemical based technologies to digital imaging technologies. Images captured by digital cameras can be stored in computers and viewed on display devices. Users can also produce image prints based on the digital images. Such image prints can be generated locally using output devices such an inkjet printer or a dye sublimation printer or remotely by a photo printing service provider. Other products that can be produced using digital images include photo books, photo calendars, photo mug, photo T-shirt, and so on. A photo book typically includes a cover page and a plurality of image pages each containing one or more images. Designing a photobook can include many iterative steps such as selecting suitable images, selecting layout, selecting images for each page, selecting backgrounds, picture frames, overall Style, add text, choose text font, and rearrange the pages, images and text, which can be quite time consuming. It is desirable to provide methods to allow users to design and produce photo albums in a time efficient manner.

### SUMMARY OF THE INVENTION

The disclosed methods and systems can provide more appealing designs to users for them to create image products such as photo books, which saves users' time spent on searching and creating product layouts.

Moreover, the disclosed methods and systems can intelligently adapt image product layout to images of different quality levels, such as images of different resolutions, and provide image products with good printing and visual qualities.

In one general aspect, the present invention relates to a method for creating an image product design. The method includes storing a plurality of page layouts for an image product; receiving a selection of one or more images for a page of an image product design by a computer system; automatically selecting, by the computer system, a first page layout in the plurality of page layouts according to the sizes of the one or more images; and producing the image product design comprising the first page layout that incorporates the one or more images.

Implementations of the system may include one or more of the following. The method can further include determining the size of the one or more images number of pixels, wherein the size includes the number of pixels along the width and the height dimensions of an image. The size of the one or more images can be retrieved from the headers of the one or more images. The page layouts can include image receiving areas associated with different image sizes, wherein the first page layout is selected according to the sizes of the one or more images and the sizes of the image receiving areas. The step of automatically selecting can include: determining, by the computer system, the image formats of the one or more images selected for the page; and automatically selecting the first page layout according to the image formats of the one or more images. The method can further include automatically selecting, by the computer system, a second page layout according to the sizes of the one or more images; and allowing a user to select the first page layout or the second page layout for the page of the image product. The method can further include receiving one or more images from one or more sources by the computer system. At least some of the one or more images can be transferred from a computer device to the computer system via a computer network. At least some of the one or more images can be transferred from a social network website to the computer system via a computer network. The image product can include a photobook that includes a page associated with the first page layout. The image product can include a photo greeting card that includes a page associated with the first page layout. The method can further include presenting the image product design, by the computer system, to a user for preview; and receiving an order from the user for a physical manifestation based on the image product design.

In another general aspect, the present invention relates to a method for assisting the design for an image product. The method includes storing a plurality of page layouts for an image product; allowing one or more users to incorporate one or more images in each of the plurality of page layouts to create designs for the image product; counting, by a computer system, the frequencies that each of the plurality of page layouts is used by the one or more users; recommending, by the computer system to a first user, a first page layout in the plurality of page layouts according to the frequencies; and allowing the first user to incorporate one or more images in the first page layout to produce a first design for the image product.

Implementations of the system may include one or more of the following. The method can further include receiving a command to create a first design for the image product from the first user; and automatically recommending the first page layout to the first user by the computer system. The step of counting can include counting the frequencies that each of the plurality of page layouts is used by the first user. The step of counting can include counting the frequencies that each of the plurality of page layouts is used by a group of users. The first page layout can have the highest frequency among the plurality of page layouts that are used by the one or more users. At least one of the plurality of page layouts can include one or more image receiving areas configured to receive one or more images. The image product can include a photobook or a photo greeting card. The method can further include presenting the first page layout by a computer system for preview by the first user.

### BRIEF DESCRIPTIONS OF THE DRAWINGS

The accompanying drawing, which are incorporated in and form a part of this specification, illustrate embodiments of the invention and, together with the description, serve to explain the principles of the invention:

FIG. 1 is a block diagram of a computer system compatible with the present invention.

FIG. 2 shows a flow chart for creating a photobook based on the qualities of the input images in accordance to the present invention.

FIG. 3 is an exemplified user interface showing a plurality of images suitable for incorporating into an image product.

FIG. 4 is a user interface showing an exemplified photobook-page layout recommended to a user based on the qualities of the input images.

FIG. 5 is a user interface showing another exemplified photobook-page layout recommended to a user based on the qualities of the input images.

FIGS. 6A and 6B illustrate an exemplified photobook design created in accordance to the present invention.

FIG. 7 shows a flow chart for automatically presenting the most popular photobook page layout to a user in accordance to the present invention.

### DETAILED DESCRIPTION OF THE INVENTION

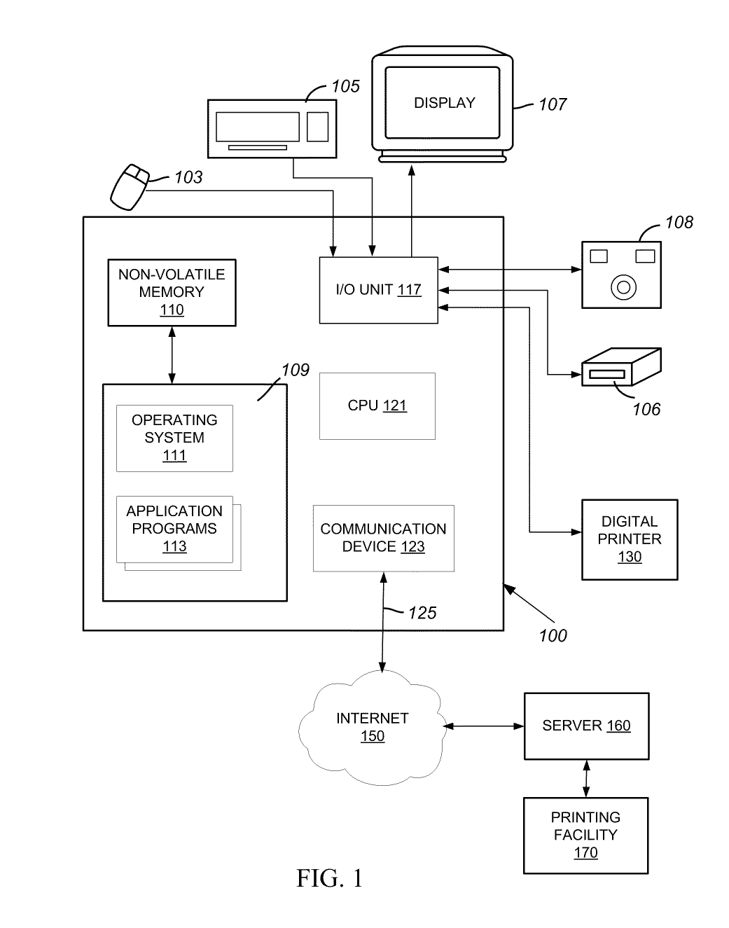

A computer system 100 illustrated in FIG. 1 represents an exemplified hardware setup for executing software that allows a user to perform tasks such as communicating with other computer users, accessing various computer resources, and viewing, creating, or otherwise manipulating electronic content, that is, any combination of text, images, movies, music or other sounds, animations, 3D virtual worlds, and links to other objects. The computer system 100 includes various input/output (I/O) devices (e.g. mouse 103, keyboard 105, display 107), a central processor unit (CPU) 121, an I/O unit 117, and a memory 109 that stores data, an operating system 111, and application programs 113. The computer system 100 also includes non-volatile memory 110 and a communications device 123 for exchanging data with a network 127 via a communications link 125 such as a cable modem, DSL service or wireless Internet connection. The digital images captured by a digital camera 108 can be transferred to the non-volatile memory 110 via wired or wirelessly connections. The images can be uploaded from the computer system 100 to a server 160 via Internet 150.

It should be noted that the computer system 100 can exist in other configurations such as a desktop computer, a laptop or tablet computer, a smart phone etc. The computer system 100 can also include a network based system including servers, databases etc., which can provide service to remote users over a computer network such as the Internet.

Although large numbers of images are frequently captured by digital cameras, only a small fraction of the digital images are used in customized imaging products, which are available from image service providers such as Shutterfly, Inc. Customizable image products can include photobooks, photo calendars, photo greeting cards, photo stationeries, photo mugs, photo T-shirt, and so on, which can provide significant enhanced ways for preserving people's treasured memories in addition to viewing images on electronic displays.

Additionally, significant obstacles exist even for creating and obtaining customizable image products. The design of a photobook, for example, can take significant amount of time and effort. A user has to select images, often from thousands of image, for many pages including a cover page. The user needs to select a format (size and cover material) and a style for the photobook. The user needs to design or select layout and a background pattern for each page, sort images for different pages, and place images onto individual pages. The photobook design can take many iterative steps such as selecting suitable images, selecting layout, selecting images for each page, add text, which can often take hours to complete.

In the present invention, the term “photo album” refers to a book that includes multiple pages, which may include photo book, photo scrapbook, photo calendars, etc. At least some of the pages include one or more images and text or image caption. The present invention concepts are also suitable for image products other than photobooks. The image products can include multiple pages (i.e. faces or views) that each can display one or more images, such as, photo greeting cards, holiday cards, multi-face photo cards, photo mugs, photo T-shirts, photo aprons, single photo pages, photo collage pages, photo stationery, photo banners, photo mugs, photo mouse pads, photo key-chains, photo collectors, and photo coasters, etc.

The style and the format of the image product can have default selections. For example, a photobook can have “everyday” and hardcover book style, and 8″ by 8″ for the photobook format. In some embodiments, the style and the format of the photobook can be selected based on knowledge of the images in the group. Specifically, an image property can be extracted from the group of identified images. For example, if the images are identified by a common tag label “Hawaii Vacation”, a photobook style for vacation, or specifically for Hawaiian vacation, may be automatically selected. In another example, if the images identified are in an electronic album called “Molly's Birthday Party”, a birthday photobook style can be automatically selected.

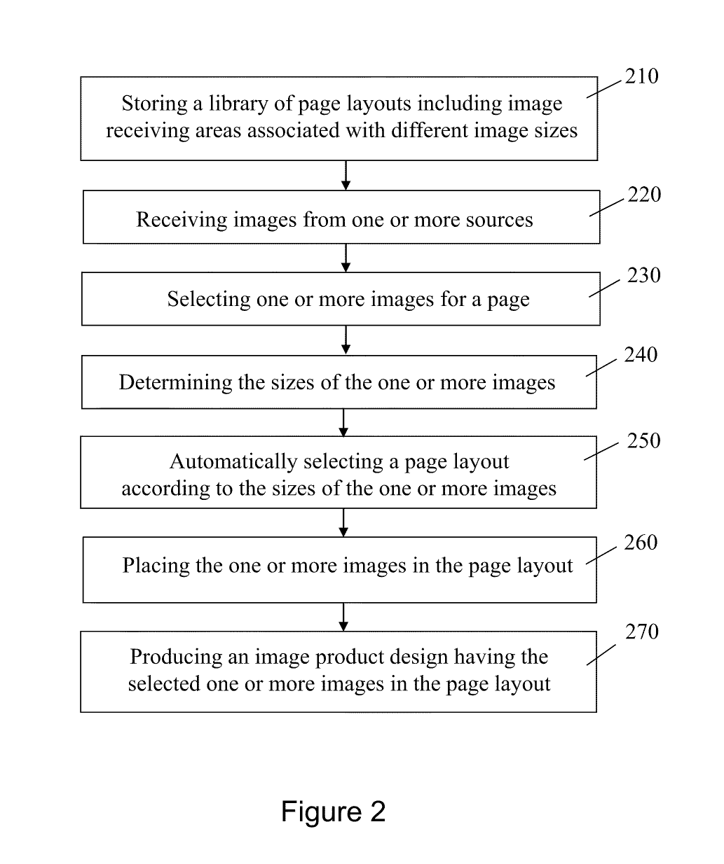

Referring to FIG. 2, a computer system stores a library of page layouts (step 210, FIG. 2). The page layouts include one or image receiving areas that have different sizes and are compatible with images of different sizes for providing desirable electronic display and printing qualities. For example, a large image receiving area is most desirably to receive a larger image. When a small image is moved into a large image receiving area, the image is scaled to a large size, which often shows image artifacts such as pixilation, non-sharpness, etc.

The computer system receives images from one or more sources (step 220, FIG. 2). The images can be obtained from digital cameras, which nowadays usually produce high resolution images. In the present disclosure, the term “high resolution” in describing an image refers to large image size. Higher image resolution or large image size usually result in better image quality for the images.

The images can also be obtained from a social network website such as Facebook or MySpace, or a photo share site such as Photobucket, Yahoo's Flickr, or Google's Picasa. The images may also be captured by camera phones or digital video cameras. In the latter cases, the images often have smaller sizes than those captured by digital cameras. The images can also be snapped by camera phones or video cameras, which may produce a range of image sizes.

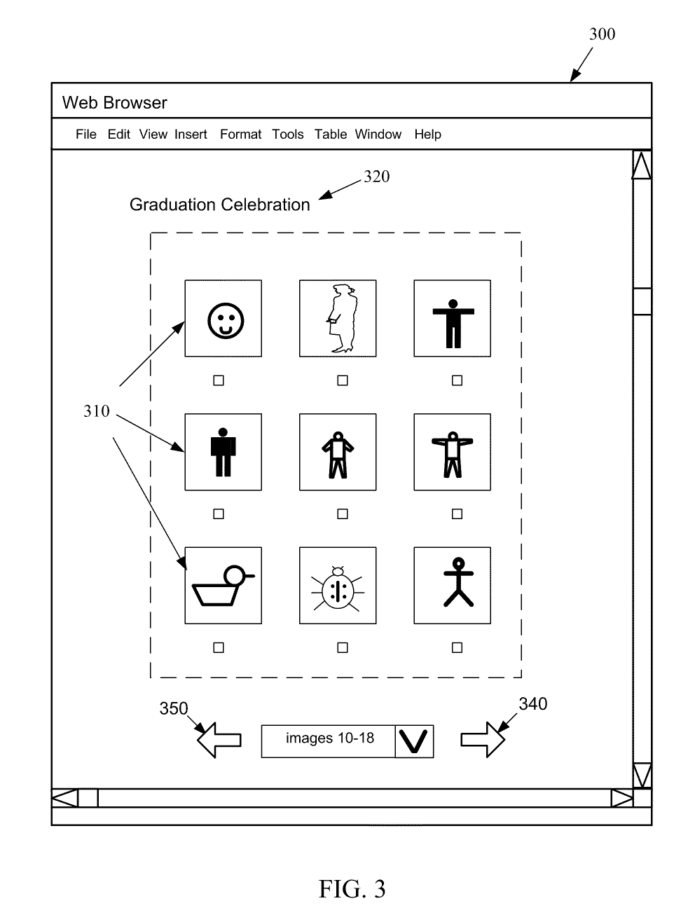

Referring to FIG. 3, images 310 from the one or more image sources are stored on the computer system and can be displayed at a user interface 300 viewable by a user. The images 310 can be held in an album 320 with a name such as “Graduation Celebration”. The computer system can automatically suggest and present a photobook style consistent with the name of the photo album (i.e. “Graduation”). The image album 320 can include several pages of images that a user can navigate to and view by clicking arrow buttons 340, 350. Furthermore, images may be tagged by a user or the service provider by labeled such as “Hawaiian Vacation”, “Soccer Team”, “Birthday Party”, “Favorite”, etc. A group of images can be identified when they are tagged by a common label such as “Hawaiian Vacation”.

Next, one or more images are selected for a page (step 230, FIG. 2). The one or more images can be manually selected by a user, or selected automatically by the computer system. For example, the images that were captured during the same event (beach, whale watching, or birthday party) can be placed on a page. The images for different pages can also be sorted according to image capture time, geo location, and color distribution.

The computer system determines the sizes (or resolutions) of the one or more images (step 240, FIG. 2). The size of an image is defined by the number of pixels along the width and height dimensions of the image. The image sizes may be stored in EXIF header associated with the images. If the image headers are not available, the images can be decompressed to bitmap images. The numbers of rows and columns of pixels in the bitmap images can be counted to obtain image sizes.

The image to be placed by the image receiving area 410 may be required to be at least 1200×1500 pixels in size so that it is not blurry when displayed in an image product comprising a page in the page layout 400. On the other hand, the image receiving areas 421-424 only require image sizes larger than 200×200 pixels.

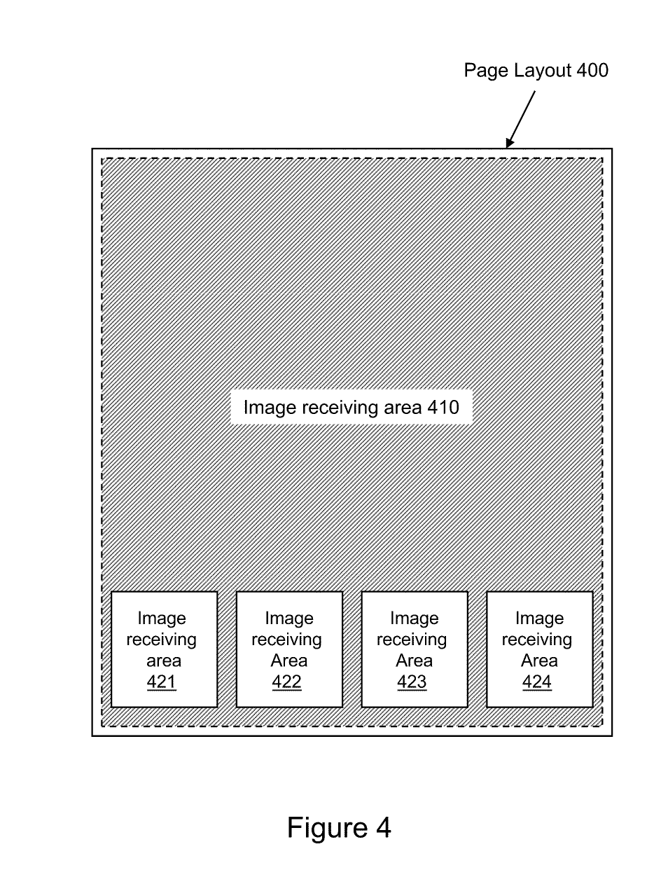

Next, a page layout is automatically selected by the computer system according to the image sizes or the image resolutions of the selected images (step 250, FIG. 2). The automatic selection can also consider the sizes of the image receiving areas in the page layouts such that the selected images can match the sizes of the image receiving areas in order to reproduce the best electronic display and printing image qualities. For example, referring to FIG. 4, a page layout 400 includes five image receiving areas 410, 421-424, which may be about a same occasion such as a social gathering. The image receiving area 410 can occupy much of the page and can be full bleed. The image receiving areas 421-424 are configured to receive much smaller images to be placed over the image received by the image receiving area 410. Five suitable images are obtained about the social event. One image may be taken a user with a digital camera, which has high resolution. Four other images may be downloaded from a blog page about the social event, which may have low resolutions. The page layout 400 is selected among many page layouts in the library that have five images including four image receiving areas that do not require high resolution images.

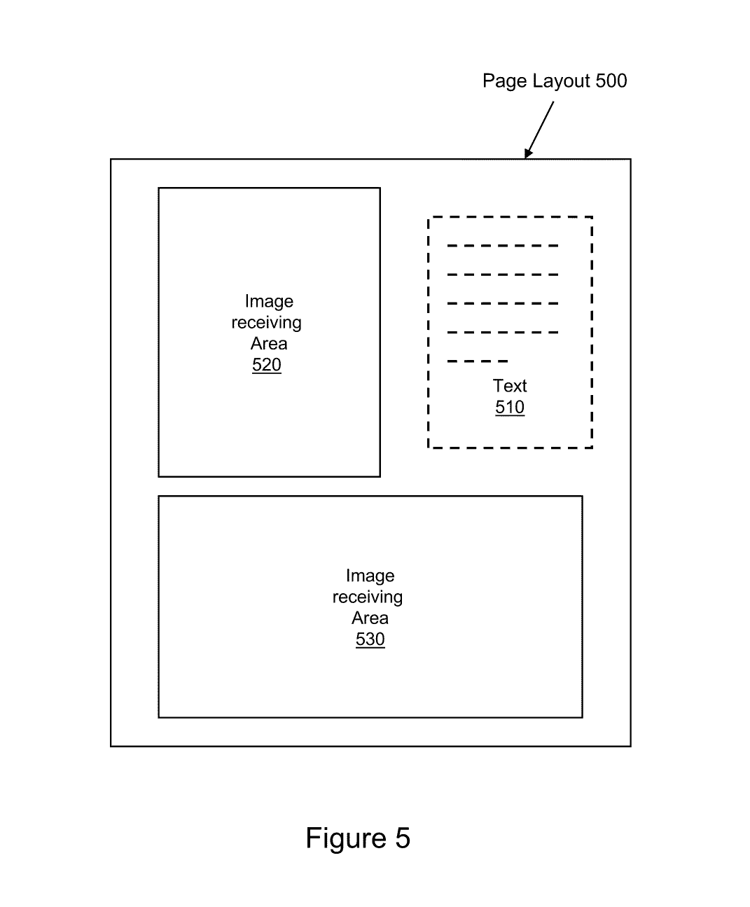

On the other hand, if two images are selected and the two images have image sizes larger than 800×1200 pixels, the page layout 500 shown in FIG. 5 can be selected for the two selected images. The page layout 500 includes a text area 510, and image receiving areas 520, 530. The images to be received by the image receiving areas 520, 530 may be required to be at least 800×1200 pixels in image sizes.

It should be noted that the automatically selected page layout serves as a suggestion to the users. The system can provide several page layouts for the user to select from, which all provide the correct number of images and associated image sizes for each page. The user has the freedom to edit and change the page layout, or select a different page layout.

In some embodiments, the computer system determines the image formats (landscape and portrait) of the one or more images selected for the page. The page layout is automatically selected by the computer system while taking into account not only the image sizes but also the image formats (landscape and portrait) of the one or more images selected for the page: the image receiving areas in the automatically selected page layout match the image formats of the one or images.

After the page layout is selected, the selected images are placed into the page layouts (step 260, FIG. 2). A design of an image product is thus created (step 270, FIG. 2). In the present disclosure, examples of the image product include a photobook, a greeting card, a calendar, photo stationery, photo gifts, etc. An image product compatible with the present invention can include one or multiple pages.

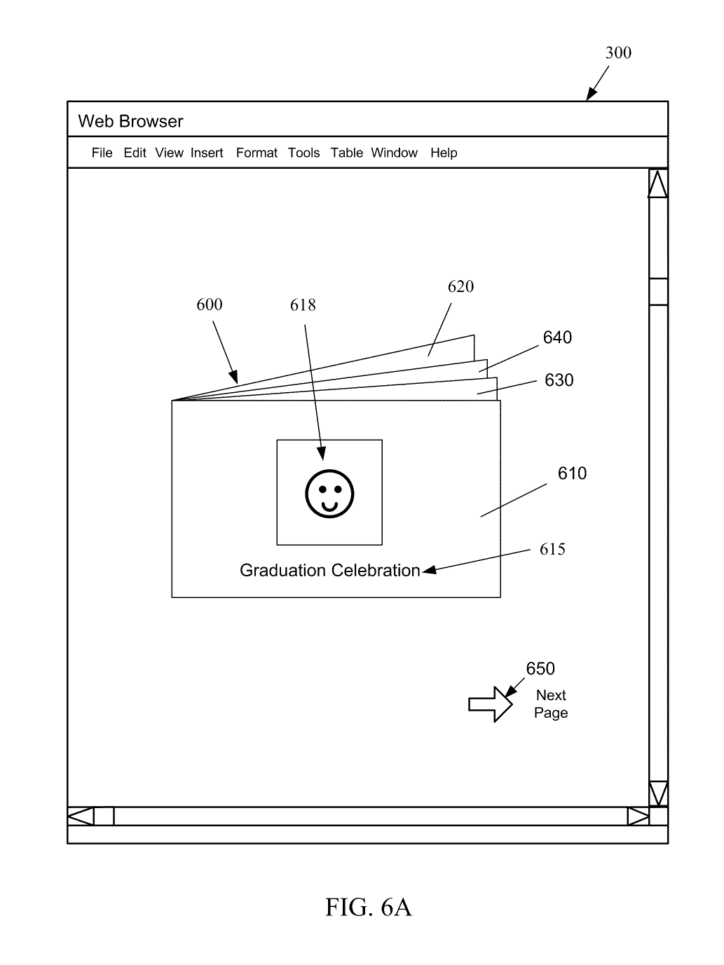

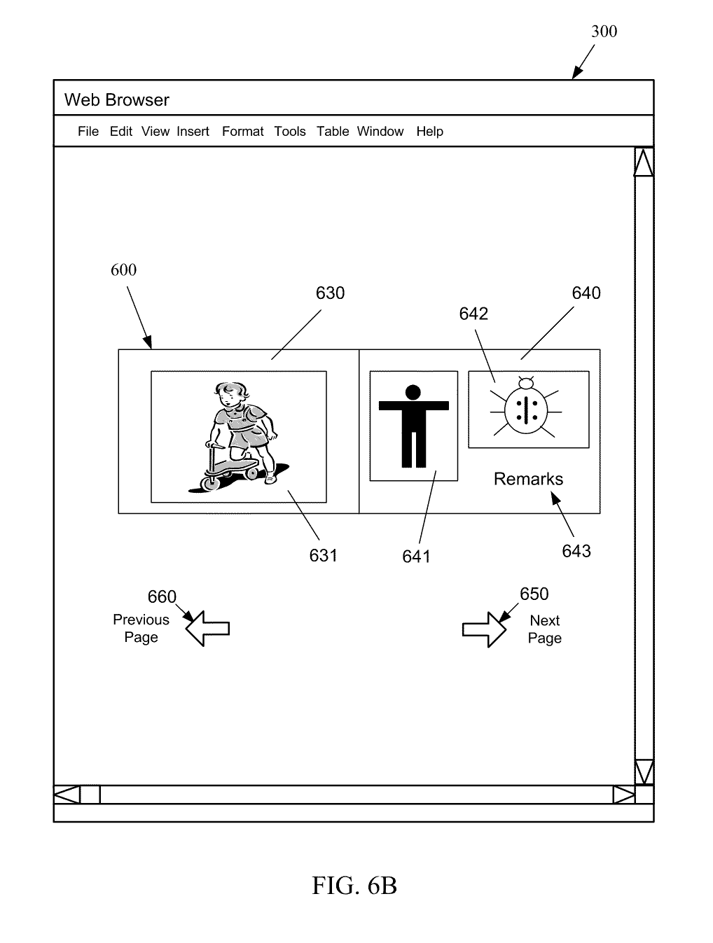

As shown in FIGS. 6A and 6B, the photobook design 600 is viewable by the user at the user interface 300 during or after the completion of the photobook design. The photobook can include a front cover 610, a back cover 620, and a plurality of pages 630, 640. The book title can be automatically selected from the name of the image album 320 (FIG. 3). The front cover 610 can include a book title 615 and an image 618 selected from the images 310 (FIG. 3). For example, the image 618 can be the first image in the album 320 or the image used (for a thumbnail image) to represent the image album 320. The page 630 can include an image 631. The page 640 can include images 641, 642, and text 643. The presentation of the photobook design 600 can include realistic illumination and texture to imitate effects of the materials in the selected book format.

The user can click arrow buttons 650, 660 to view different pages of the photobook. The cover and different pages of the photobook design 600 can also be played automatically like a slide show. The user is allowed to edit the design of the photobook design 600. The user can change, switch, or remove the images 618, 631, 641, and 642 on the book cover 610 and pages 630, 640. The user can also change text information such as the book cover 615 and the text 643. After the user has reviewed and optionally edited the photobook design 600, the user can save the photobook design 600. Once the user approves a design, the photobook can be made according to the design locally by a printer 130 (FIG. 1), or remotely by an imaging service provider at a printing facility 170 (FIG. 1).

In some embodiments, the page layouts presented to the users can be prioritized according to the popularity of the page layouts. More popular page layouts can be presented the users because there is higher likelihood of acceptance by the users.

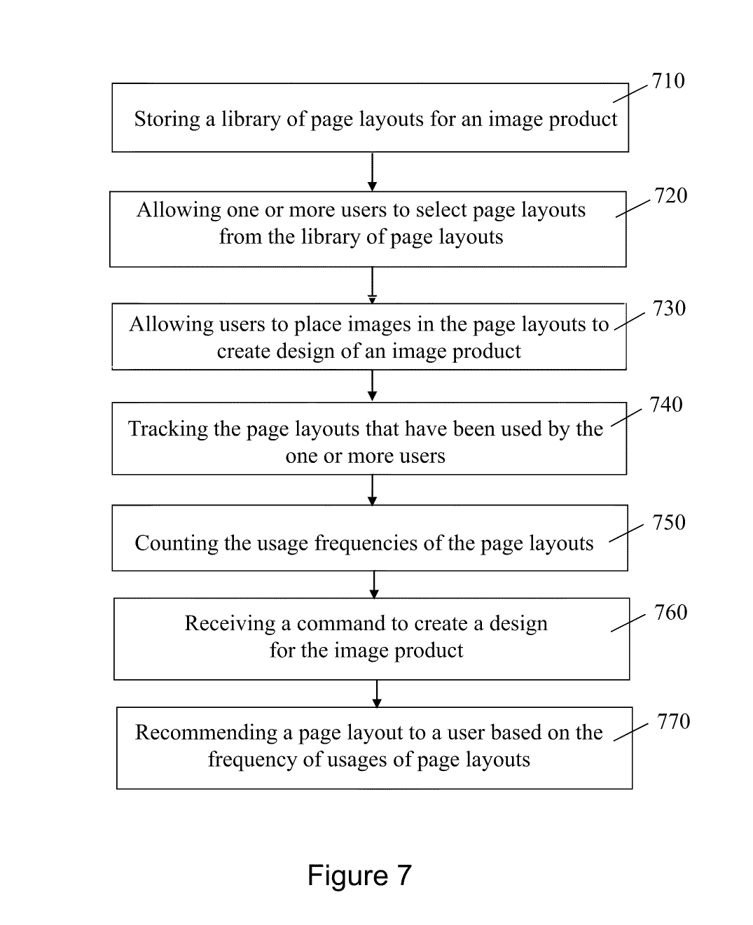

Referring to FIG. 7, a library of page layouts is stored for an image product in a computer system (e.g. 100 in FIG. 1) (step 710). Each page layout can include a background image, clip arts, etc., as shown in FIGS. 4 and 5. The page layout can include one or more image receiving areas and one or more text areas. Alternatively, the page layout can include a canvas which allows a user to freely introduce images and text at different positions on the page and with adjustable image and text sizes. The computer system can be a computer device such as a desktop computer, a laptop or tablet computer, a smart phone etc. The system can also include a network based system including servers, databases etc., which can provide service to remote users over a computer network such as the Internet.

The user can select page layouts from the library of page layouts (step 720) in creating image products using their images or images available to them. The users can place images in the page layouts to create design of an image product (step 730).

The computer system can track frequencies of the page layouts used by a large number of users in creating their image products (step 740). The tracking of page layouts can be categorized by the number images per page (number of ups: two up, three up, etc.), styles of the photobook (spring, summer, holiday, etc.), occasions (graduation, wedding, sports, etc.), etc. The usage frequencies of the page layouts are counted (step 750), which indicates page layouts' popularities. The popularity of page layouts can be measured specific to a user, among a group of users, or among all users of specific image software or a website.

When the computer system receives a command from a user to create an image product design (step 760), the most popular page layout(s) (for a user, a group of users, or all the users) can be automatically recommended to the user (step 770). For example, if the page layout 400 (FIG. 4) is the most popular for a user (or a group of users, or all the users) for five-up page layouts (a page containing five images), the page layout 400 can be recommended as the top choice to the user(s).

In some embodiments, the page layout can be automatically used and automatic formation of an image product once the user commands the image product (e.g. a photobook) is to be created using her images. For example, if the page layout 500 (FIG. 5) is the most popular for a user for two-up page layouts (a page containing two images), the page layout 500 can be automatically used by the computer system to incorporate the user's images. The user can subsequently edit the images and page layouts in the photobook design. In some embodiments, the most popular page layout is the default for the user to use.

In some embodiments, the page layouts presented to the users are rank-ordered according to their degree of popularities. The more popular page layouts are placed on the top (or more highly recommended), which makes it easier for the user to choose from, and thus significantly saving users' time.

It should be understood that the presently disclosed systems and methods are suitable for proactively creating different image products other than photobooks. The image products can include multiple pages or views that each can display one or more images, such as, photo books, photo calendars, photo scrapbooks, photo snapbooks, photo calendars, photo albums, and a multi-face photo card. The image products can also include a single page or view for displaying one or more images, which can include, for example, photo greeting cards, holiday cards, stationery cards, photo mugs, photo T-shirts, photo aprons, single photo pages, photo collage pages, a photo stationery, photo banners, photo mugs, photo mouse pads, photo key-chains, photo collectors, and photo coasters etc.

Furthermore, it should be understood that the library of page layout contains layouts with different numbers of images other than one, two, and three. For a given number of images on a page and for the given formats of the images, the page layout is not limited to the designs shown in this application. There can be a large variation of layout designs for the same number of images with the same formats on each page. Moreover, the sorting and grouping of images can be implemented by other approaches or using other metrics. The illustration of page grouping and page breaks for the images can also vary within the scope of the present disclosure. Moreover, the presently disclosed systems and methods are compatible with a software application installed locally on a computer device, client software in communication with a remote server, or a software application installed on a central server.

What is claimed is:

1. A method for creating an image product design, comprising:
storing a plurality of page layouts for an image product;
receiving a selection of one or more images for a page of an image product design by a computer system;
automatically selecting, by the computer system, a first page layout in the plurality of page layouts according to the sizes of the one or more images; and
producing the image product design comprising the first page layout that incorporates the one or more images.

2. The method of claim 1, further comprising:
determining the size of the one or more images number of pixels, wherein the size includes the number of pixels along the width and the height dimensions of an image.

3. The method of claim 2, wherein the size of the one or more images are retrieved from the headers of the one or more images.

4. The method of claim 2, wherein the page layouts comprise image receiving areas associated with different image sizes, wherein the first page layout is selected according to the sizes of the one or more images and the sizes of the image receiving areas.

5. The method of claim 1, wherein the step of automatically selecting comprises:
determining, by the computer system, the image formats of the one or more images selected for the page; and
automatically selecting the first page layout according to the image formats of the one or more images.

6. The method of claim 1, further comprising:
automatically selecting, by the computer system, a second page layout according to the sizes of the one or more images; and
allowing a user to select the first page layout or the second page layout for the page of the image product.

7. The method of claim 1, further comprising:
receiving one or more images from one or more sources by the computer system.

8. The method of claim 7, wherein at least some of the one or more images are transferred from a computer device to the computer system via a computer network.

9. The method of claim 7, wherein at least some of the one or more images are transferred from a social network website to the computer system via a computer network.

10. The method of claim 1, wherein the image product comprises a photobook that includes a page associated with the first page layout.

11. The method of claim 1, wherein the image product comprises a photo greeting card that includes a page associated with the first page layout.

12. The method of claim 1, further comprising:
presenting the image product design, by the computer system, to a user for preview; and
receiving an order from the user for a physical manifestation based on the image product design.

13. A method for assisting the design for an image product, comprising:
storing a plurality of page layouts for an image product;
allowing one or more users to incorporate one or more images in each of the plurality of page layouts to create designs for the image product;
counting, by a computer system, the frequencies that each of the plurality of page layouts is used by the one or more users;
recommending, by the computer system to a first user, a first page layout in the plurality of page layouts according to the frequencies; and
allowing the first user to incorporate one or more images in the first page layout to produce a first design for the image product.

14. The method of claim 13, further comprising:
receiving a command to create a first design for the image product from the first user; and
automatically recommending the first page layout to the first user by the computer system.

15. The method of claim 13, wherein the step of counting comprises counting the frequencies that each of the plurality of page layouts is used by the first user.

16. The method of claim 13, wherein the step of counting comprises counting the frequencies that each of the plurality of page layouts is used by a group of users.

17. The method of claim 13, wherein the first page layout has the highest frequency among the plurality of page layouts that are used by the one or more users.

18. The method of claim 13, wherein at least one of the plurality of page layouts comprises one or more image receiving areas configured to receive one or more images.

19. The method of claim 13, wherein the image product comprises a photobook or a photo greeting card.

20. The method of claim 13, further comprising:
presenting the first page layout by a computer system for preview by the first user.
